(19) United States
(12) Patent Application Publication
(10) Pub. No.: US 2021/0040940 A1
(43) Pub. Date: Feb. 11, 2021

(54) Portable Air Pump AMD Power Device

(71) Applicant: Shi Qi ZHU, Mclean, VA (US)

(72) Inventor: Shi Qi ZHU, Mclean, VA (US)

(21) Appl. No.: 16/602,067

(22) Filed: Aug. 5, 2019

(51) Int. Cl. F04B 35/06; F04B 35/04

(52) U.S. Cl. CPC F04B 35/06; F04B 2207/042; F04B 35/04

(57) ABSTRACT

A portable air pump assembly is constructed with a power bank with flashlight, USB output, laptop output, a 12V appliance connection port, a jump start clamp, and an air pump with three adaptors for inflating different devices including car tires, inflatable toys, camping furniture and sports equipment. A portable air pump assembly comprising: an enclosed pistol shaped housing defining a central chamber adapted to hold a plurality of pump components the pump components comprising a driving assembly mounted inside said enclosed housing. A pivotal trigger assembly is mounted to the housing which controls power to said motor and a display cap mounted on the rear of said pistol shaped housing, the display cap showing pressure values generated by the pump mechanism, and a portable power source adapted to be connected with the electric motor through the universal connection port and a control circuit.

### RELATED APPLICATIONS

There are no related patent applications.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

### 1. Field of Invention

The present invention is directed generally to a hand held portable air pump provided with a universal power port and a remote electrical power supply device.

### 2. Description of the Prior Art

Previously portable air pumps were designed to be manually operated by using both hands. During operation, the user had to hold the pump body with one hand and operate the pumping handle with the other hand. The user gets tired quickly when operating the air pump in this manner.

U.S. Pat. No. 8,007,258 issued Aug. 30, 2011 is directed toward a portable air pump which includes a tubular body, a piston mechanism having mounted to one end of the tubular body with the other end of the tubular body being screwed to a head assembly. A barrel is moveably mounted around the tubular body. This pump is manually operated and as the tubular body is axially moved in relation to the barrel. When the barrel is pulled towards the head assembly, air in the bottom of the barrel is compressed and flows through the center hole of the piston up through the tubular body and out through the head and the dispensing head.

U.S. Pat. No. 7,494,035 issued Feb. 24, 2009 discloses a portable compressor which can be powered alternatively by either a battery or an AC power source. The compressor has a permanent magnet DC electric motor and circuitry for converting the AC power source to DC power. The compressor includes a receptacle for accommodating one or more of a plurality of batteries and includes circuitry for using batteries having different voltages. The AC power source may also be used to charge a battery connected to the compressor.

U.S. Pat. No. 6,439,104 issued Aug. 27, 2002 is directed towards a small size air pump having a motor which is driven by a remote power source to actuate a pump section. The motor drives a worm gear disposed on an output shaft of the motor and engages and drives a worm wheel and a small gear disposed coaxial with the worm wheel. The small gear meshes with a larger gear drive connected to the end part of a piston of a compression cylinder.

U.S. Pat. No. 5,931,207 issued Aug. 3, 1999 discloses a hand held two piece plastic housing containing a battery powered compressed air power unit for spraying liquids from a tank or for inflating inflatable items. The unit has a trigger operated battery system and an external alternate power port mounted in the housing under the spray nozzle. This alternate power source can be used with a conventional external source of electrical power such as a cigarette lighter in a vehicle. A power source having an electric motor and an air compressor are mounted inside the housing and an air gauge shows the air pressure at the top of the housing and leads to the liquid tank allowing the aire pressure to be read directly from the handle of the power unit.

U.S. Pat. No. 5,639,226 issued Jun. 17, 1997 is directed toward a portable battery operated air pump having a base plate with an electric motor mounted on the base plate. The motor has a drive shaft, with a toothed driving gear which engages a driving wheel having teeth positioned around it's periphery. The driving wheel is rotatably supported on a pin which is affixed to the base plate to drive and rotate the drive wheel. A cylindrical piston has a distal end pivotally affixed to a pivot pin mounted on the forward end of the base plate A piston rod is mounted to said drive wheel with the other end forming a piston head.

U.S. Pat. No. 5,127,808 issued Jul. 7, 1992 is directed toward a battery operated air pump for a bicycle having a cylindrical shape allowing it to be carried in the rack used for a water bottle carrier. The motor, drive gearing and compression components are carried in the cylindrical body. A rear display cap for the pump contains an on button, an off button and a recharging port

U.S. Pat. No. 4,874,296 issued Oct. 17, 1989 discloses a portable air compressor driven by an electric drill. The drill housing is formed of tapered clam shell halves molded from a plastic material which encloses a gear assembly driven by the drill bit and the cylinder, piston rod and piston head. Power is supplied to an electric drill which uses the rotation of the drill bit to turn a gear assembly to reciprocate a piston in a cylinder and discharge the compressed air through a discharge tube to the object receiving the pressurized air.

U.S. Pat. No. 4,830,579 issued May 16, 1989 is directed toward a compressor kit for use with motor vehicles. The compressor kit has an electrical cord which is plugged into the cigarette lighter socket of a vehicle. The case is wired so that it supplies electricity to thee compressor held by the case and also to a light held by the case. The light may be unplugged from its connection with the case as may be the conductor which leads from the cigarette lighter socket, and the conductor may then be plugged into the removable light to provide a portable light.

U.S. Pat. No. 3,243,100 issued Mar. 29, 1966 discloses a portable case holding a compressor for use in the treatment of congestive ailments such as asthma or emphysema. An electric motor carried in the case drives an eccentric plate which drives a piston rod and associated piston head into a compression cylinder head to compress air which is inhaled by a patient or user.

U.S. Pat. No. 1,414,573 issued May 2, 1929 discloses an air pump mounted on an arm member. The pump is driven by a piston driving wheel which receives its motion from a crank driven belt. A piston rod is eccentrically mounted on the driving wheel with the other end of the rod secured to a piston head which is reciprocated within the compression cylinder.

What is needed in the industry is a portable air pump which can be used in a myriad of ways, is adjustable to deliver pressurized air at a desired value within a usable psi range, can be used during the day or at night and is easily transportable or can be simply stored in the trunk of the family vehicle.

The prior art has attempted to solve the problems shown and discussed but has been unable to provide a solution to same.

The present invention is directed to a handheld air pump and portable power unit for powering an air pump, a laptop, powering a 12 volt appliance, 2 USB output, flashlight, inflate the car tires, bicycle tires, inflatable toys and sports equipment at any time. The product is constructed with a power bank with flashlight, USB output, laptop output, a 12V appliance connection port, a jump start clamp, and an air pump with three adaptors for different devices including car tires, inflatable toys, camping furniture and sports equipment. The air pump can be powered by 12V/10 A output, or by EC-5 output of the power bank, or by car cigarette 12V output.

The present invention overcomes these problems and current problems and deficiencies are solved by this invention in the manner described below.

### SUMMARY OF THE INVENTION

Specifically the present invention portable air pump assembly has an enclosed pistol shaped housing defining a central chamber adapted to hold a plurality of pump components and the compression cylinder. The pump components comprise an electric motor with a drive gear mounted on the drive shaft, the drive gear engaging a drive wheel to rotate the drive wheel and an eccentric cam connected to the drive wheel. A piston rod is mounted on one end to the eccentric cam and a piston head is mounted on the other end of the piston rod. The piston reciprocates within a chamber defined by a fixed compression cylinder to compress air within said cylinder and discharge the compressed air into a hose with an outlet port. A portable power source is connected with an electric control circuit through a universal port in the pump to deliver power to the pump.

It is an object of this invention to provide a portable powered air pump having a universal 12 V port in the pump.

It is another object of the invention to provide a hand held powered portable air pump which can be preset for a range of specific psi discharges up to 150 psi.

It is yet another object of the invention to provide an easily assembled and disassembled portable hand held air pump which can be converted into multiple uses.

It is still another object of the invention that when the desired psi number is reached, that the pump will shut off automatically.

It is still another object of the invention to utilize a hand held portable powered pump which can be preset to deliver compressed air at a predetermined psi or other desired value or to increase or decrease the compression psi while working on the inflated object.

These and other objects, advantages, and novel features of the present invention will become apparent when considered with the teachings contained in the detailed disclosure along with the accompanying drawings.

### BRIEF DESCRIPTION OF THE DRAWINGS

The present invention will be described with reference to the appended FIGS. 1-14, in which:

FIG. 1 is a perspective rear and side view of the present air pump invention;

FIG. 2 is a perspective bottom and side view of the air pump assembly shown in FIG. 1;

FIG. 3 is a side elevational view of the air pump housing shown in FIG. 1 with the rear display cap being enlarged and exploded showing settings and controls;

FIG. 4 is a reversed side view of the air pump housing of FIG. 3 with one of the housing clam shells removed showing the pump mechanism, motor and compression cylinder with the power supply being shown schematically and the pump nozzle being shown in phantom;

FIG. 5 is an enlarged top view of the air pump housing as shown in FIG. 4;

FIG. 6(a) is an enlarged partial perspective view of the compression shaft and piston head in the rearward position of the piston stroke in the compression cylinder;

FIG. 6(b) is an enlarged partial perspective view of the compression shaft and piston head in the forward position of the piston stroke in the compression cylinder;

FIG. 7 is an enlarged top plan view of the adaptor storage area as seen in FIG. 1 formed on the top of the air pump housing with various adaptors mounted thereon;

FIG. 8(a) is an enlarged perspective view of a narrow adaptor;

FIG. 8(b) is an enlarged perspective view of the ball pin adaptor

FIG. 8(c) is an enlarged perspective view of the wide adaptor;

FIG. 9 is an enlarged view of the opposite clam shell which has been removed from the housing shown in FIG. 4;

FIG. 10 is a perspective view of the charger module with an LCD shown in exploded view;

FIG. 11 is a front elevational view of the charger/power module shown in FIG. 10;

FIG. 12 is a perspective schematic view of the air pump being powered by the engine start port of the power module;

FIG. 13 is a perspective schematic view of the air pump being powered by a vehicle accessory port;

FIG. 14 is a schematic view of an electric control circuit to deliver power from the power source through the pump universal port to the pump; and

FIG. 15 is an exploded perspective view of a jump start accessory assembly used with the invention.

### DESCRIPTION OF THE INVENTION

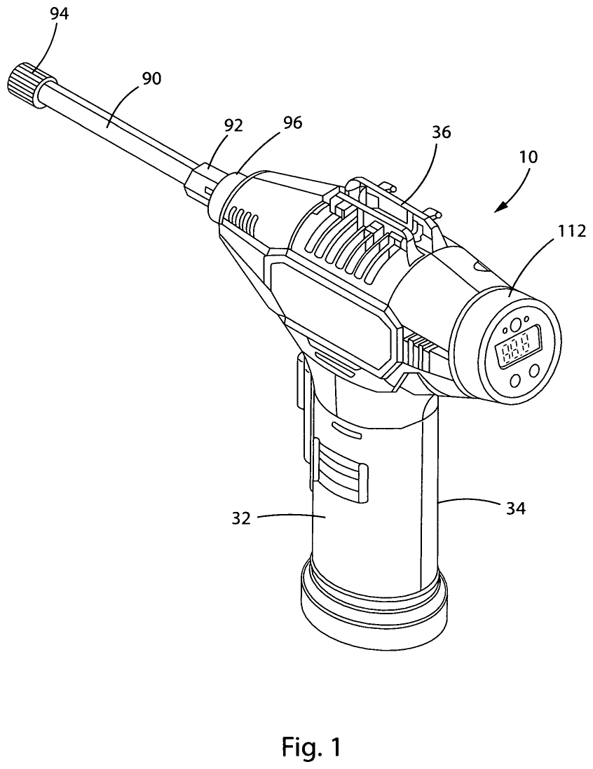

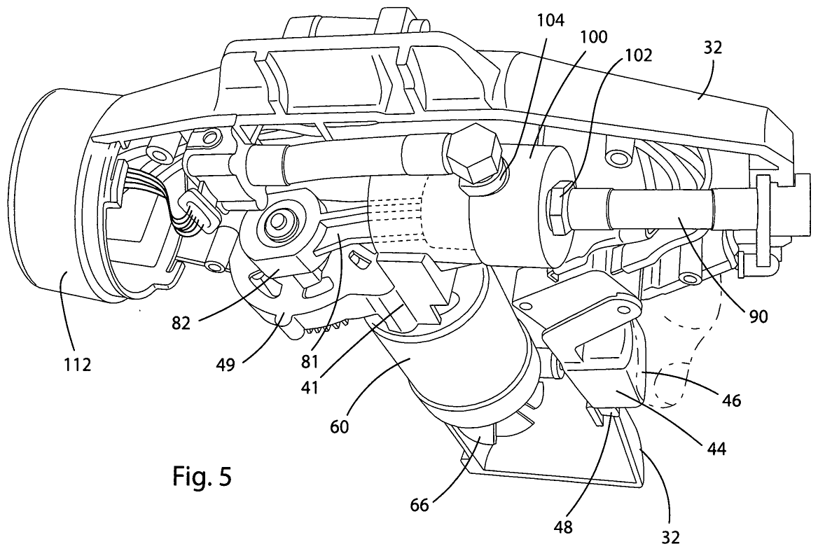

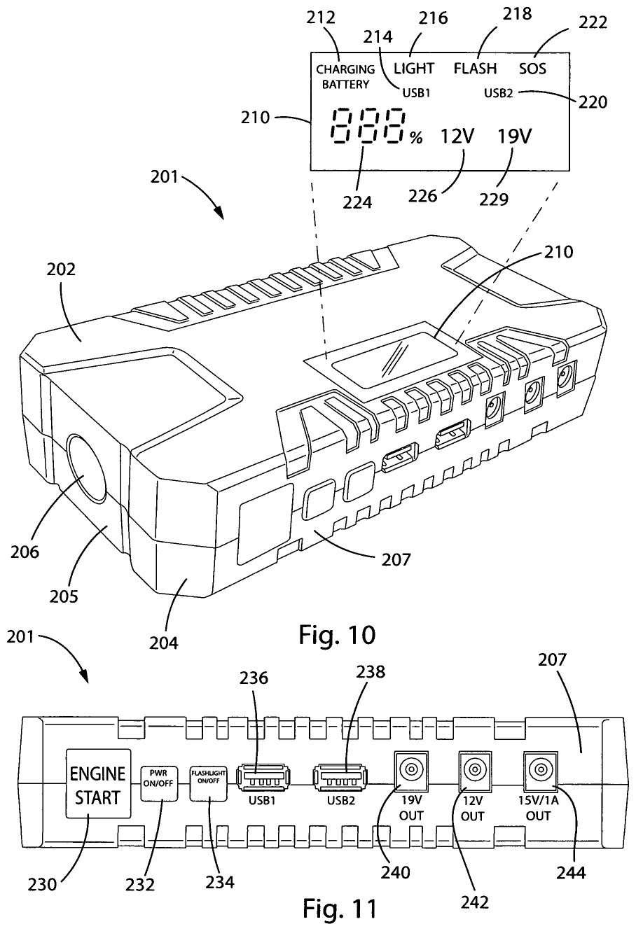

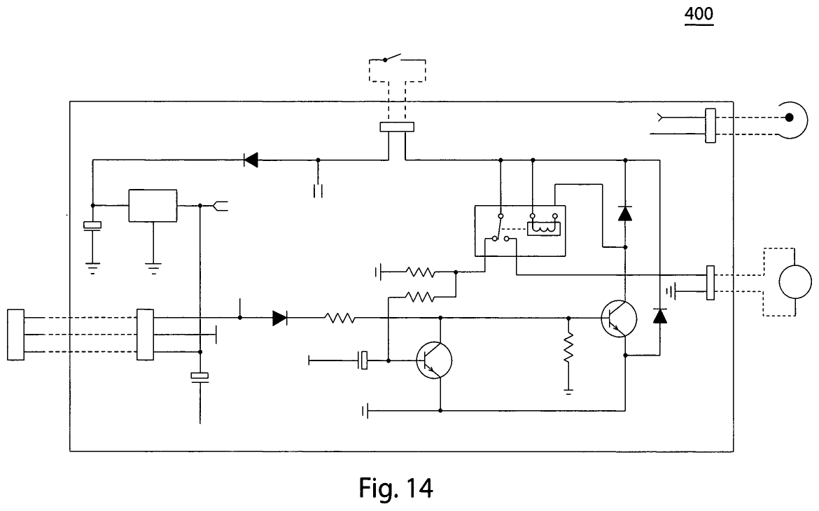

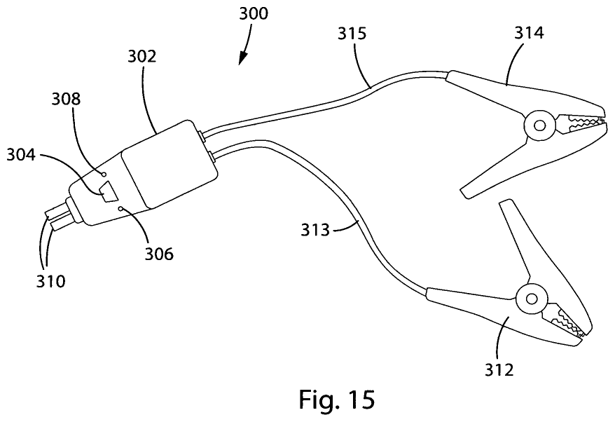

The best mode and preferred embodiment of the portable hand held air pump 20 is shown by FIGS. 1-9 and 14, the power module is shown in FIGS. 10-13 with a jump start accessory being shown in FIG. 15.

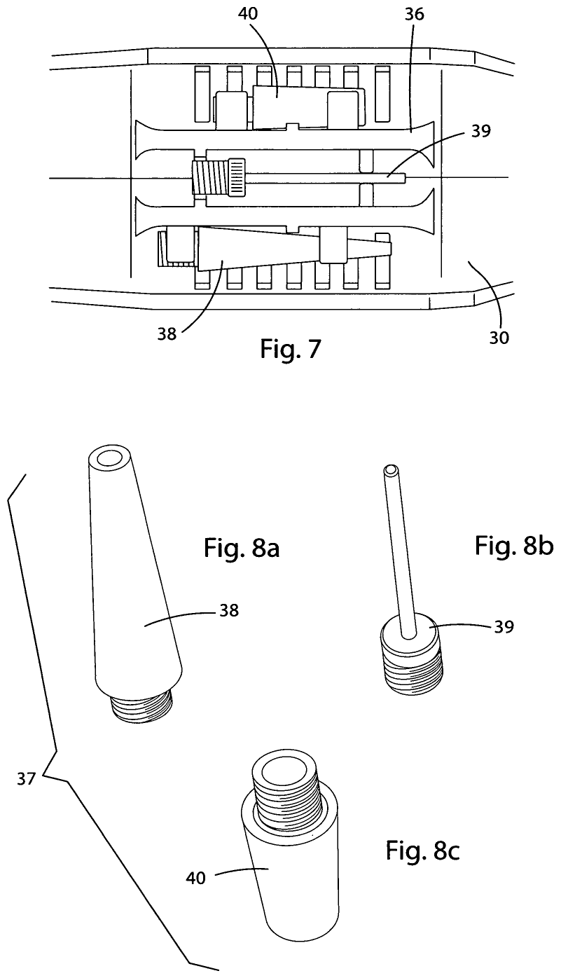

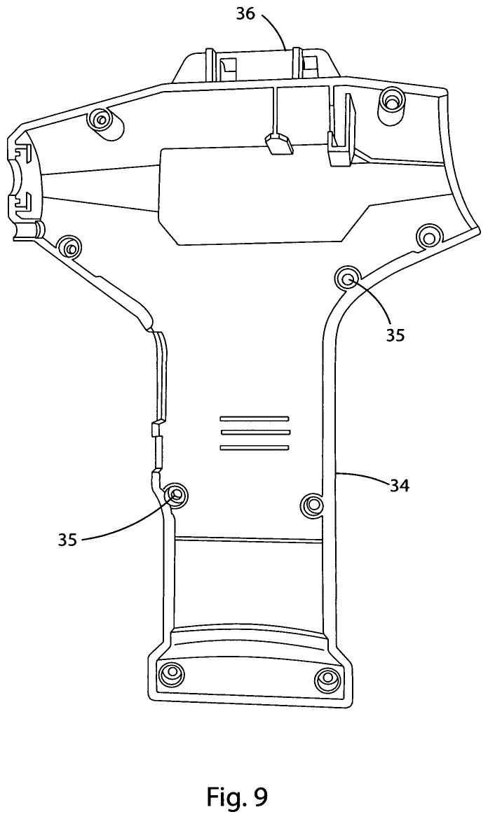

The present inventive portable air pump assembly 20 comprises a pistol shaped outer plastic housing 30 formed of two separate plastic shells, 32 and 34 which form a handle section and a barrel section communicating together with the barrel section extending from the handle section. The shells 32 and 34 are connected together by fasteners (not shown) in the form of screws inserted through the bores 35 of housing shell 34 as seen in FIG. 9 into the aligned threaded holes 35(a) formed in posts extending away from housing shell 32. As shown in FIGS. 1 and 7 the top of the plastic housing 30 defines an accessory storage area 36 which holds a plurality of adaptors 37 allowing the pump to fit a number of articles such as motorcycle, vehicle and bicycle tires, inflatable sports balls such as footballs, soccer balls, volley balls and basketballs, beach balls and other water sports inflatables. The adaptors 37 are shown in the multiple versions (a) through (c) of FIG. 8 such as the narrow adaptor 38, the ball pin adaptor 39 and a wide adaptor 40.

A light 42 is mounted under the barrel 41 in a recess 43 to provide light on the object inflated or worked upon. Mounted below the light is a pivotal trigger assembly 44 which controls power to the motor 60. The trigger assembly 44 is biased outward by a coil spring 45 which is mounted around a post (not shown) extending outward but located inside the trigger housing 46 with the distal end of the spring engaging a planar stop member 47 extending from section 32 of the housing. A sliding lock member 48 is mounted on the housing below the trigger and can be slid upward to lock the trigger in position.

A flexible rubber air hose 90 has an exhaust port 92 at its proximal end which serves as a screw connector and is mounted to the circular recess 96 at the end of the housing barrel. The other end of the hose 90 is formed with an air chuck 94 which will receive an adaptor tip 37. The tip in turn will fit into the item to be inflated.

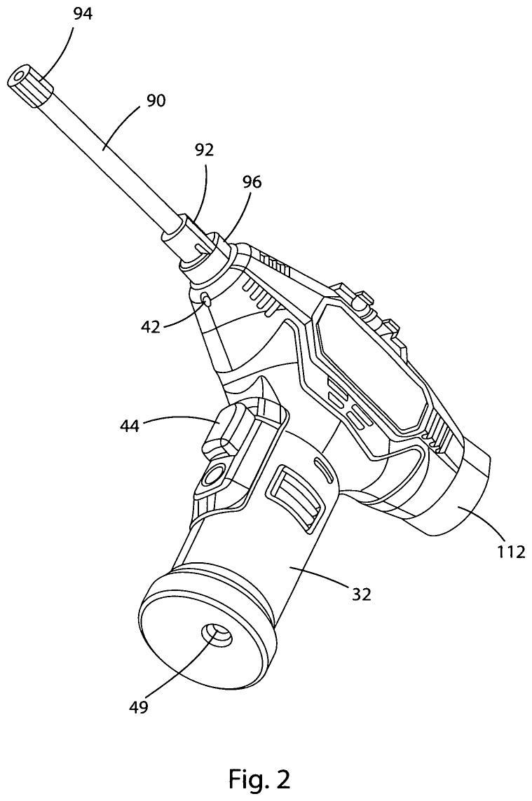

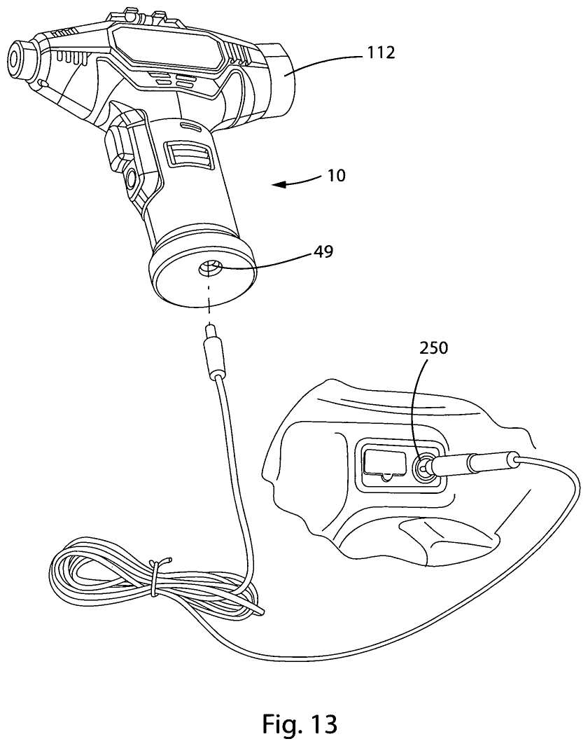

There is a universal power port 49 located in the bottom of the handle as shown in FIG. 2 which can receive power from a power module 200, a vehicle as shown in FIG. 13 or other source of power.

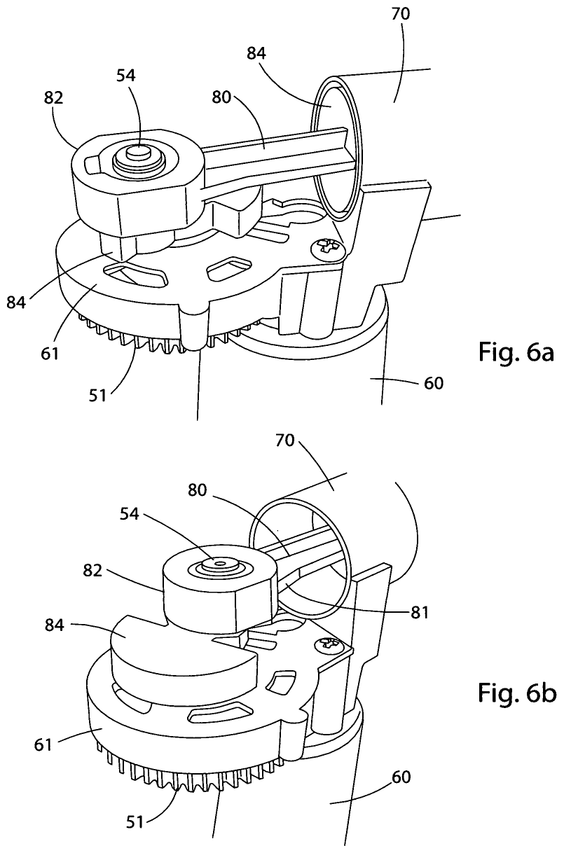

A centrally positioned drive wheel housing 61 is mounted inside the housing shell 32 to the motor exterior and cylinder 70. The drive wheel housing 61 holds a circular driven wheel 50 which is mounted on pivot pin 52 which in turn is mounted to the center of driven wheel 50 as shown in FIGS. 6(a) and 6(b). The circular drive wheel 50 is provided with teeth 51 on its outside periphery. A motor 60 is mounted on a seat 38 extending inwards from the interior wall of housing shell 32. The motor 60 has a drive shaft 62 which holds a driving gear 64 on one end which engages the teeth 51 of the drive wheel 50 to drive the circular driven wheel 50 when the motor is turned on. The opposite end 63 of drive shaft 62 holds a propeller fan 66 which rotates when the drive shaft rotates blowing air across the motor 60 cooling the same. It should be noted that a window 64 is cut in the motor housing 65 adjacent a secondary cooling fan 67 located on the drive shaft inside the motor housing 65 and above the propeller fan 66. The cooling fan 64 serves as a secondary cooling unit for the motor 60.

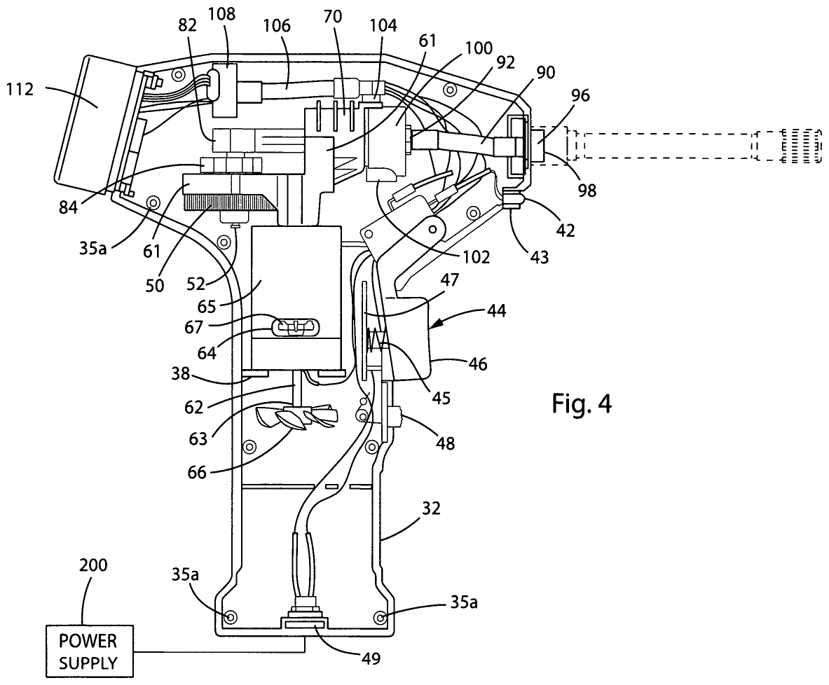

The front proximal section of the drive wheel housing 49 is formed into a cylinder 70 and defines a tapered throughgoing aperture or chamber 71 leading into the cylinder 70 which receives piston rod 80 and piston 82. The piston rod 80 has a tapered end 81 as seen in FIGS. 6(a) and 6(b). The piston rod 80 has its tapered end 81 ending at an integral mounting member 82. The mounting member 82 is mounted to a pin 54 which is secured to an eccentric cam 84 which is mounted above the drive wheel 50 and the other distal end secured to a piston head 82. It should be noted that the air cylinder 70 is fixed to the wheel housing 49 and has a front extension member 100 which is axially aligned with the center axis of the piston cylinder. The extension member 100 has an air intake boss 102 leading into the cylinder to supply air to the cylinder as seen in FIG. 4 and an air discharge boss 104 opposite the air intake boss 102 connected to conduit 106. Conduit 106 runs back across the top of the cylinder and communicates with a pressure gauge 108. The pressure gauge 108 relays pressure information to the end control display 110 where it is displayed.

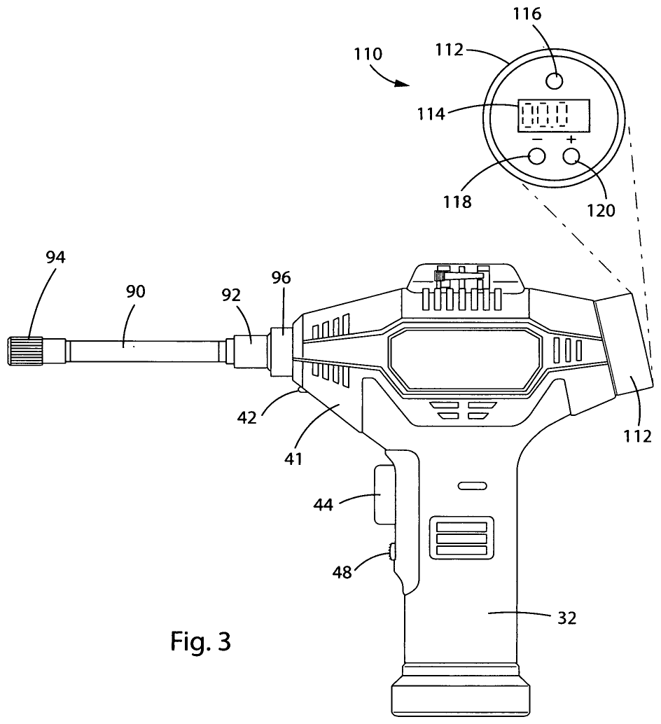

The end display 110 as shown in FIGS. 1 and 3 is in the form of a removable cap 112 having an LED light 114 which shows units and values. These units and buttons are used to determine the desired unit and values for operation of the air pump. The set button 116 chooses the desired unit (psi, BAR, KPA, Kg/cm²). The minus or negative (−) button 118 is used to choose the lower value and the positive button (+) 120 is used to select a higher value. The user presses and holds the negative button 118 or the positive button 120 to accelerate numerical change. After the screen flashes three (3) times, the screen will show “0” and the system will enter the chosen unit. When the desired unit and value has been set (e.g. psi 30) the circuitry running the end display shuts off the pump automatically when the set psi number has been reached. The manufacturers preset pressure is 30 PSI and the air pump has memory functions located in the cap circuitry.

A power transfer board 130 is mounted to the trigger housing under the cylinder 70 and transfers power to light 140 mounted adjacent the barrel for illumination of the object being inflated. Power is also transferred to the motor 60 from the power source through the universal port 49 which is electrically connected to control circuit 400 to deliver power to the pump. The motor 60 drives the driving wheel 50 to compress air in the cylinder 70.

The power module 200 as shown in FIGS. 10-13 is a two piece housing 201 with the top section 202 being fastened to a bottom section 204. The sections are preferably constructed of plastic which is substantially shock proof. The front section 205 of the housing 201 is provided with an LED flashlight 206. A LCD screen 210 is mounted on a top planar portion of housing section 202 and gives the user visual readings for the following functions: the LCD screen 210 also gives readings (on or off) for the following: the 15V/1 A charging input 212, the 5V/2.4 A output 214 (USB1), the light steady on 216, the light flash 218, the 5V/2.4 A output 220 (USB2), the light SOS 222, battery capacity 224 (by percentage), the 12V output 226, and the 19V output 228.

A side wall 207 of the housing 201 is provided with a series of sockets, buttons and ports for multi-use operability. A engine start button 230 is located at the forward end of the plug strip. Located next to the start button 230 is the power on and off button 232, followed by a flashlight button 234, and USB outlet ports 236 (USB1) and 238 (USB2) for charging/running computers. Moving toward the rear of the power module are a 19V output port 240 to run/charge laptops, a 12V output port 242 to run/charge appliances and a 15V/la input port 244.

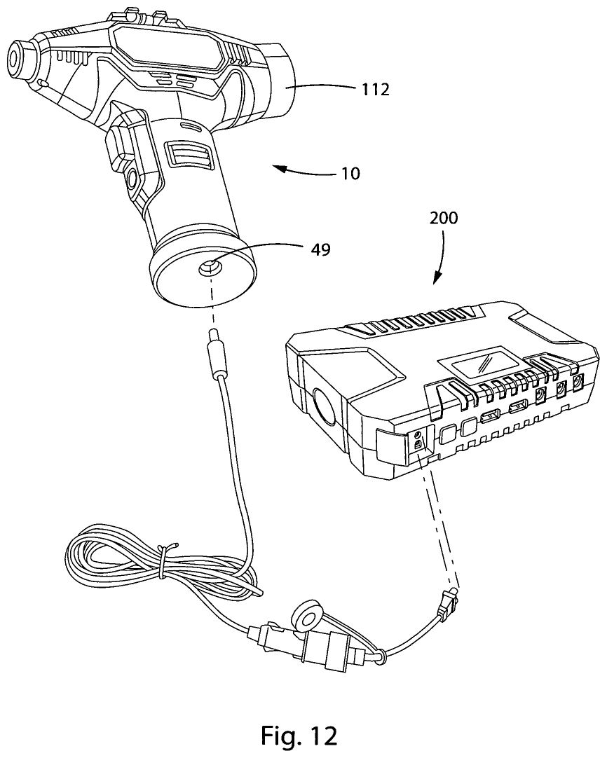

The air pump 10 can be powered with the power module 200 car charger and the 12V adapter as seen in FIG. 12 One end of the car charger is connected to the 12V adapter and the other end to the universal port 49 at the bottom of the handle of the air pump. The air pump can also be directly powered from a vehicle as shown in FIG. 13. One end of the car charger is connected to the bottom universal outlet 49 at the bottom of the handle of the air pump and the other end is directly connected to the end of the vehicle 12V accessory outlet 250 as shown in FIG. 13

An accessory jumper cable assembly 300 as seen in FIG. 15 can be provided along with the charger assembly for jump starting engines. This jumpstarting is for a 12V lead-acid battery only. The assembly 300 is provided with a plug housing 302 having a boost button 304, a red LED 306 and a green LED 308 and an end EC5 plug 310. The reverse polarity protection and short circuit protection features are disabled after boost button 304 is pressed. A red positive clamp 312 is electrically connected to the housing 301 by an insulated line 313 and a black negative clamp 314 is electrically connected to the housing 301 by insulated line 315.

It should be understood that, while the description of the invention herein discloses a system in which inflation methods are shown the invention can be utilized for numerous other jobs.

The present air pump system according to the invention operates faster and more accurately than manually operated systems, is lighter in weight and easier to handle, allows adjustments to system components in real time to achieve optimum operating performance, significantly reduces labor and operating costs, decreases system failures, increases system life, and improves system reliability.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A portable air pump assembly comprising:
an enclosed housing defining a central chamber adapted to receive pump components;
an intermediate housing mounted in said housing,
a driving assembly mounted to said intermediate housing, said driving assembly comprising an electric motor with a drive shaft, a drive gear mounted on said drive shaft, said drive gear engaging a drive wheel to rotate said drive wheel and associated gearing to reciprocate a piston rod and piston head within a fixed compression cylinder to compress air within said cylinder, discharge means mounted at one end said compression cylinder to discharged compressed air from said cylinder into an outside conduit, and
a universal port mounted to said housing, an electric control circuit positioned inside said enclosed housing electrically connected with said motor and said universal port to deliver power from an outside portable power source to said pump.

2. A portable air pump assembly as claimed in claim 1 wherein said portable power source is a battery operated portable charging apparatus.

3. A portable air pump assembly as claimed in claim 1 wherein said enclosed housing is a two piece plastic housing held together by fastening means.

4. A portable air pump assembly as claimed in claim 1 wherein said pressurized air is compressed within said cylinder to a range of about 10 psi to about 150 psi.

5. A portable air pump assembly as claimed in claim 1 wherein said compression cylinder has a tapered entry chamber for said piston rod.

6. A portable air pump assembly as claimed in claim 1 wherein said circuit control board is configured to automatically stop said pump when a designated pump pressure is reached.

7. A portable air pump assembly as claimed in claim 1 wherein said motor is secured to said housing, said driving wheel is mounted in said intermediate housing and said compression cylinder is mounted to said housing.

8. A portable air pump assembly as claimed in claim 1 wherein a circuit board is mounted in said housing, said circuit board transferring power to said motor and to an external light mounted in said housing.

9. A portable air pump assembly as claimed in claim 1 wherein a LED memory device is mounted to said housing, said LED memory device allowing for different air pressure and allowing said air pressure to be increased and decreased.

10. A portable air pump assembly as claimed in claim 1 wherein said housing defines an accessory storage area, said storage area containing a plurality of adaptors including a ball pin adaptor, a wide adaptor and a narrow adaptor.

11. A portable air pump assembly comprising:
an enclosed pistol shaped housing provided with a handle section and a barrel section defining a central chamber adapted to hold a plurality of pump components;
said pump components comprising a driving assembly mounted inside said enclosed housing, said driving assembly comprising an electric motor with a drive shaft, a drive gear mounted on said drive shaft, said drive gear engaging a drive wheel which rotates said drive wheel and an eccentric cam connected to said drive wheel, a piston rod mounted to said eccentric cam with a piston member mounted on the other end of said piston rod, said piston being reciprocally moveable within a chamber defined by a fixed compression cylinder mounted on said inside said enclosed housing to compress air within said cylinder and discharge said compressed air into a pipe with an outlet port, said compression cylinder being fed with air from a port communicating with said cylinder chamber;
a display cap mounted on the rear of said barrel section, said display cap showing pressure values generated by said pump mechanism, and allowing specific pressure to be set,
a portable power source module removed from said housing adapted to be electrically connected with said housing.

12. A portable air pump assembly as claimed in claim 11 wherein said housing defines a recess under said barrel section which holds a light mounted in said recess to provide light on the object being worked upon.

13. A portable air pump assembly as claimed in claim 11 wherein a pivotal trigger assembly is mounted to said housing which controls power to said motor, said trigger assembly being biased outward by a spring which engages said trigger assembly and said housing.

14. A portable air pump assembly as claimed in claim 14 wherein said trigger assembly includes a sliding lock member, said sliding lock member being mounted on said housing below said trigger assembly and can be slid upward to lock said trigger in position.

15. A portable air pump assembly as claimed in claim 14 wherein said trigger assembly has a trigger housing and a post extending away from said housing to hold said trigger spring.

16. A portable air pump assembly as claimed in claim 11 wherein said display cap has a screen which can be adjusted to visually show air values in units by psi, BAR, KPA, Kg/cm²

17. A portable air pump assembly as claimed in claim 11 wherein there is a universal electrical power port located in the bottom of the handle section which is electrically connected to said motor.

18. A portable air pump assembly comprising:
an enclosed pistol shaped housing defining a two piece housing forming a handle section and a barrel section which together define a central chamber adapted to hold a plurality of pump components, the bottom of said handle being provided with a universal power connection port electrically connected to an electric motor mounted within said housing;
said pump components comprising a driving assembly mounted inside said enclosed housing, said driving assembly comprising an electric motor with a drive shaft, a drive gear mounted on said drive shaft, said drive gear engaging a drive wheel which rotates said drive wheel and an eccentric cam connected to said drive wheel, a piston rod mounted to said eccentric cam with a piston member mounted on the other end of said piston rod, said piston being reciprocally moveable within a chamber defined by a fixed compression cylinder mounted on said inside said enclosed housing to compress air within said cylinder and discharge said compressed air into a pipe with an outlet port, said compression cylinder being fed with air from a port communicating with said cylinder chamber;
a pivotal trigger assembly is mounted to said housing which controls power to said motor, said trigger assembly being biased outward by a spring means which engages said trigger assembly and said housing.
a display cap mounted on the rear of said pistol shaped housing, said display cap showing pressure values generated by said pump mechanism, and
a portable power source adapted to be connected electronically with said electric motor through said universal connection port and a control circuit.

19. A portable air pump assembly as claimed in claim 18 wherein said motor and pump components can generate compressed air in a range of 10 psi to 150 psi.

20. A portable air pump assembly as claimed in claim 18 wherein a pivotal trigger assembly is mounted to said housing, said trigger assembly controlling electrical power to said motor, said trigger assembly being continuously biased outward by a spring means which engages said trigger assembly and said housing.
